(19) United States
(12) Patent Application Publication
(10) Pub. No.: US 2018/0211270 A1
(43) Pub. Date: Jul. 26, 2018

(54) MACHINE-TRAINED ADAPTIVE CONTENT TARGETING

(71) Applicant: Business Objects Software Ltd., Dublin (IE)

(72) Inventors: Ying Wu, Maynooth (IE); Paul Pallath, Naas (IE); Achim Becker, Kirkel (DE)

(21) Appl. No.: 15/415,534

(22) Filed: Jan. 25, 2017

(51) Int. Cl. G06Q 30/02

(52) U.S. Cl. CPC G06Q 30/0204; G06Q 30/0269

(57) ABSTRACT

Systems and methods for machine-trained adaptive content targeting are provided. The system generates a recommendation model, which includes creating a plurality of offer clusters. Each offer cluster comprises offers having similar features. The system assigns a new offer to one of the plurality of offer clusters. The assigning of the new offer occurs without having to retrain the recommendation model. The system also generates a plurality of user clusters, whereby users within each of the plurality of user clusters share similar behavior. A classification model for predicting an offer cluster from the plurality of offer clusters is created for each of the plurality of user clusters. The system then performs a recommendation process for a new user that includes selecting one or more relevant offers from a predicted offer cluster based on the classification model.

### TECHNICAL FIELD

The subject matter disclosed herein generally relates to machines configured to the technical field of special-purpose machines that facilitate content targeting, including computerized variants of such special-purpose machines and improvements to such variants, and to the technologies by which such special-purpose machines become improved compared to other special-purpose machines that facilitate content targeting. Specifically, the present disclosure addresses systems and methods to train a machine to perform adaptive content targeting.

### BACKGROUND

In recent years, recommender systems are playing an increasingly important role in helping users find relevant information of potential interest to them. The recommender systems aim to identify and suggest useful information that is of potential interest to users by observing user behaviors. Good recommendations allow users to quickly find relevant information buried in a large amount of irrelevant information. At the same time, recommendation techniques help to maximize profits, minimize risks in a business, and improve loyalty because users tend to return to sites that provide better experiences.

There has been a wide range of machine learning methods used in product recommendation, such as Bayesian network, decision tree, association rule, and neural network. Most of these methods are performed in a similar way whereby a recommendation model is trained in batch-learning by using user ordering data and product descriptions. Such product recommendation processes are performed based on the assumption that the products being sold are relatively stable. When new products are added, the recommendation model needs to be completely retrained so that new products can be included into recommendation options. As such, product recommendation processes require product attributes that are stable, and model retraining is mandatory when there is any change in product attributes. As a result, such product recommendation processes are not flexible enough to be used in an offer (e.g., promotions) recommendation process.

### BRIEF DESCRIPTION OF THE DRAWINGS

Some embodiments are illustrated by way of example and not limitation in the figures of the accompanying drawings.

FIG. 1 is a block diagram illustrating components of an offer management system suitable for machine-trained adaptive offer targeting, according to some example embodiments.

FIG. 2 is a flowchart illustrating operations of a method for training a machine for adaptive offer targeting and recommending most relevant offers, according to some example embodiments.

FIG. 3 is a flowchart illustrating operations of a method for creating offer clusters, according to some example embodiments.

FIG. 4 is a graph illustrating a determination of an optimal number of offer clusters, according to some example embodiments.

FIG. 5 is a flowchart illustrating operations of a method for assigning a new offer to an offer cluster, according to some example embodiments.

FIG. 6 is a flowchart illustrating operations of a method for dynamically recalibrating offer clusters, according to some example embodiments.

FIG. 7 is a flowchart illustrating operations of a method for processing a historical user dataset, according to some example embodiments.

FIG. 8 is a flowchart illustrating operations of a method for creating user clusters and classification models, according to some example embodiments.

FIG. 9 is a flowchart illustrating operations of a method for assigning a user cluster to a new user, according to some example embodiments.

FIG. 10 is a flowchart illustrating operations of a method for selecting a specific offer for the new user, according to some example embodiments.

FIG. 11 is a block diagram illustrating components of a machine, according to some example embodiments, able to read instructions from a machine-readable medium and perform any one or more of the methodologies discussed herein.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Example methods (e.g., algorithms) facilitate automatically training a machine for adaptive content targeting and recommending relevant content (e.g., offers, also referred to herein as “promotions”) to users, while example systems (e.g., special-purpose machines) are configured to train a machine for adaptive content targeting and to provide recommendations of relevant content (e.g., offers) to user. In particular, example embodiments provide mechanisms and logic that cluster similar offers into offer clusters, cluster similar users into user clusters, and use a corresponding classification model to recommend a reasonable group of one or more relevant offers to the user. The mechanisms and logic also allow a new offer to be added and recommended without having to retrain the entire recommendation process or recommendation model.

While product recommendations focus on a shopping basket and aims to predict products that the customers are likely buying next, offer recommendation focuses on promotions. More specifically, offer recommendation aims to predict promotions that a user is likely to accept. Based on such difference, offer recommendation has its own unique features. For example, since promotions are strategies released according to a real-time operation, promotions may be much more dynamic than products (e.g., promotions change more frequently). Additionally, promotions have a much shorter life cycle than products. Further still, promotions may be defined by very different policies and have varying structures. For instances, a simple offer structure may be buy one item and get a discount on the price, while a complex offer structure may be buy a specified product and get another specific product for free.

The example recommendation system and method needs to be flexible enough to include or exclude promotions without the necessity of retraining the entire recommendation process or recommendation model, should allow changing an offer structure without retraining the entire recommendation process or model, and the offers recommended by the example system and method should reflect a user's preferences and their purchase behaviors. Accordingly, a system generates a recommendation model, which includes creating a plurality of offer clusters. Each offer cluster comprises offers having similar features. The system assigns a new offer to one of the plurality of offer clusters, for example, by computing a distance to a centroid of each of the plurality of offer clusters and associating the new offer with an offer cluster with a shortest distance to the centroid. The assigning of the new offer occurs without having to retrain the recommendation model. The system also generates a plurality of user clusters, whereby users within each of the plurality of user clusters share similar behavior. A classification model for predicting an offer cluster from the plurality of offer clusters is created for each of the plurality of user clusters.

The system then performs a recommendation process for a new user. The recommendation process includes selecting one or more relevant offers from a predicted offer cluster based on the classification model. In particular, the system predicts a user cluster of the plurality of user clusters to assign to the new user and identifies the predicted offer cluster that corresponds to the predicted user cluster based on the classification model. The one or more relevant offers are selected by determining a group of users within the predicted user cluster with similar behavior as the new user, and ranking offers within the predicted offer cluster based on acceptance of the offers by the group of users. The one or more relevant offers may be the top ranked offers.

As a result, one or more of the methodologies described herein facilitate solving the technical problem of providing machine-trained adaptive offer targeting without having to constantly retrain the system each time a new offer or a new user (e.g., new recommendation made for the new user) is added to the system. As such, one or more of the methodologies described herein may obviate a need for certain efforts or resources that otherwise would be involved in the system having to constantly retrain whenever a change is made within the system. As a result, resources used by one or more machines, databases, or devices (e.g., within the environment) may be reduced. Examples of such computing resources include processor cycles, network traffic, memory usage, data storage capacity, power consumption, network bandwidth, and cooling capacity.

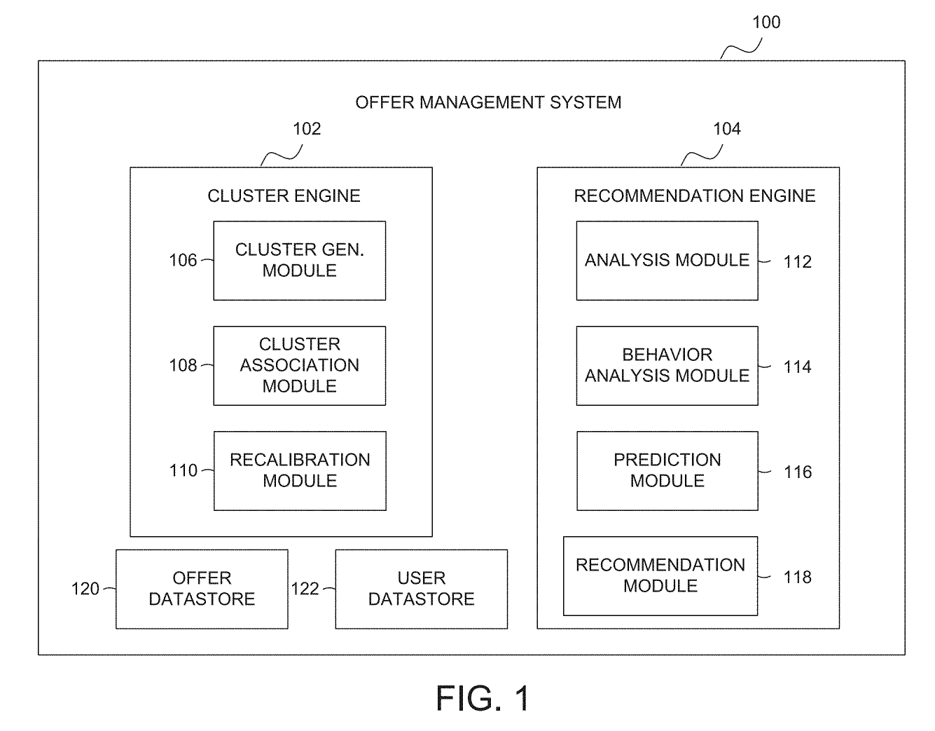

FIG. 1 is a block diagram illustrating components of an offer management system 100 suitable for machine-trained adaptive offer targeting, according to some example embodiments. The offer management system 100 comprises one or more servers configured to train for (e.g., learn) adaptive offer targeting and to provide most relevant offers to users. The offer management system 100 includes a cluster engine 102 and a recommendation engine 104. The cluster engine 102 manages the adaptive offer targeting training (or learning) and offer clusters by building offer clustering model. The offer clustering groups an existing set of offers into a plurality of offer clusters where offers assigned to a same offer cluster share similar structures and features. When a new offer is presented to the offer management system 100, the new offer is associated with an offer cluster of the plurality of offer clusters that is most similar (e.g., having the most similar structures and features). The recommendation engine 104 manages the recommendation of relevant offers to a user. In particular, the recommendation engine 104 analyzes behavior of the user and assigns the new users to their corresponding user clusters based on the analysis (e.g., the new user is associated with the user cluster that has the most similar features or attributes). An individual offer recommendation model is built for each user cluster. An offer cluster is predicted (e.g. selected as most relevant) for a new user by applying the recommendation model of the user cluster that the new user is assigned to. A specific offer from the selected offer cluster is recommended based on information captured in the past for a set of users in the user cluster that have similar behaviors as the new user (e.g., bought or searched a similar category of items) and that have opted for an offer from the selected offer cluster.

In example embodiments, the cluster engine 102 comprises a cluster generation module 106, a cluster association module 108, and a recalibration module 110, while the recommendation engine 104 comprises an analysis module 112, a behavior analysis module 114, a prediction module 116, and a recommendation module 118 all configured to communicate with each other (e.g., via a bus, shared memory, or a switch). The offer management system 100 also includes, or is coupled to, an offer datastore 120 that stores historical offer data and a user datastore 122 that stores historical user data including user attributes and interactions.

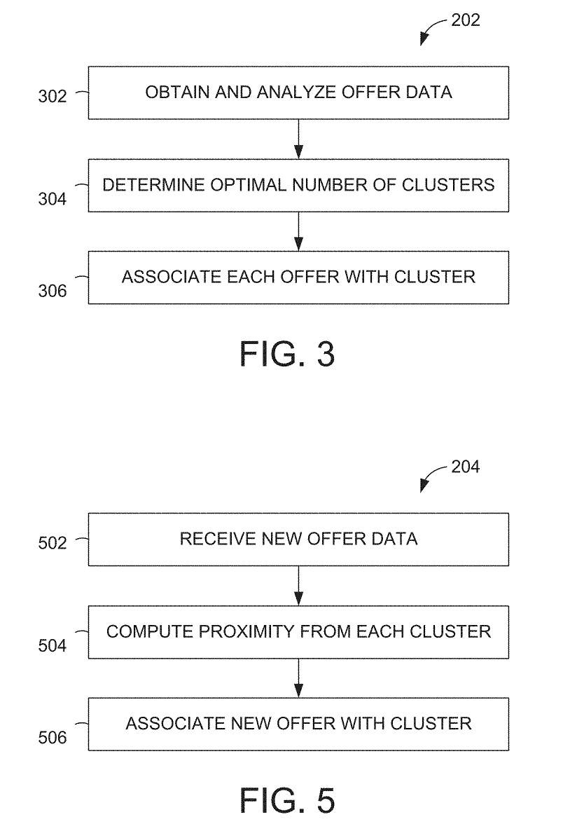

With respect to the cluster generation module 106, the cluster generation module 106 generates an offer clustering model comprising a plurality of offer clusters (e.g., based on the historical offer data). In particular, the cluster generation module 106 applies clustering algorithms in order to group existing offers into offer clusters where the offers in the same offer cluster share similar features. The features may comprise, for example, item or item type, length of offer, type of offer (e.g., discount), or other meta-information. Operations of the offer training module 106 are discussed in more detail in connection with FIG. 3.

The cluster association module 108 is configured to assign a new offer to one of the plurality of offer clusters generated by the cluster generation module 106. In example embodiments, a determination of which offer cluster to assign the new offer to is based on a distance between the new offer and a centroid of each offer cluster in the plurality of offer clusters, where the offer cluster having a smallest distance is selected. Operations of the cluster association module 108 are discussed in more detail in connection with FIG. 5.

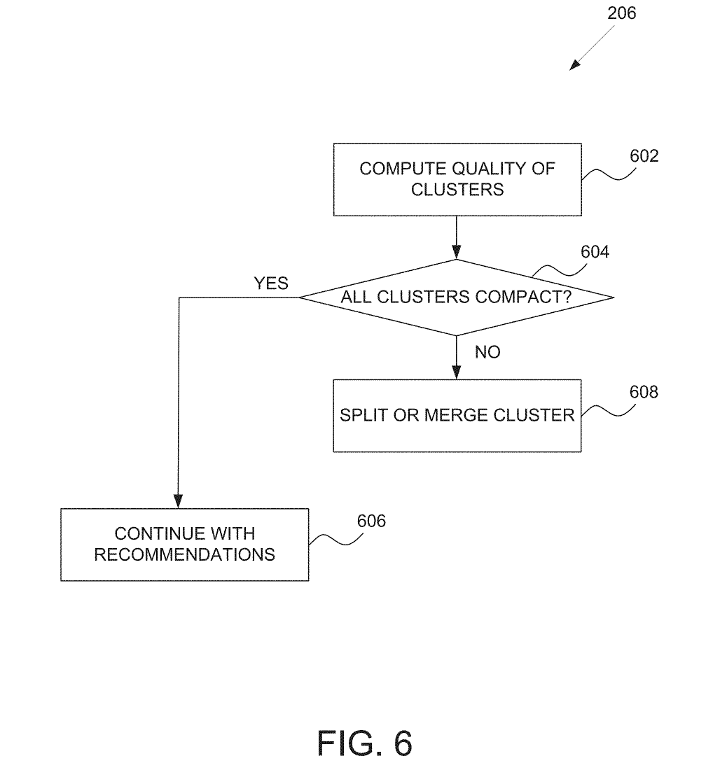

The recalibration module 110 is configured to dynamically recalibrate offer clusters when needed. Recalibration does not retrain the entire offer clustering system or derive a completely new plurality of offer clusters. Instead, the recalibration module 110 determines after a threshold number of new offers are added (e.g., 100 new offers), whether one or more offer clusters need to be adjusted. If one or more offer cluster needs adjusting, the recalibration module 110 will adjust only those offer cluster(s) (e.g., split an offer cluster or merge two offer clusters together). Operations of the recalibration module 110 will be discussed in more detail in connection with FIG. 6.

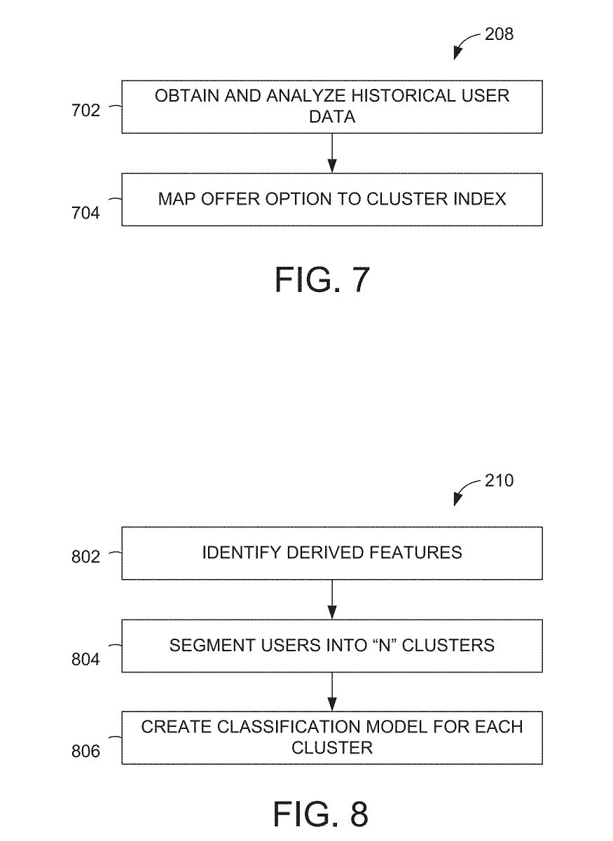

With respect to the recommendation engine 104, the analysis module 112 processes historical user data (e.g., stored in the user datastore 122). In particular, the analysis module 112 analyzes the historical user data and manages mapping of each offer option (e.g., an offer that was selected by previous users) from the historical user data to an offer cluster (e.g., cluster index) created by the cluster engine 102. Operations of the recommendation training module 112 are discussed in more detail in connection with FIG. 7.

The behavior analysis module 114 trains/learns user clustering models to extract user clusters. In particular, the behavior analysis module 114 applies clustering algorithms in order to group users into user clusters where the users in the same user cluster share similar attributes and/or interactions. Operations of the behavior analysis module 114 are discussed in more detail in connection with FIG. 8.

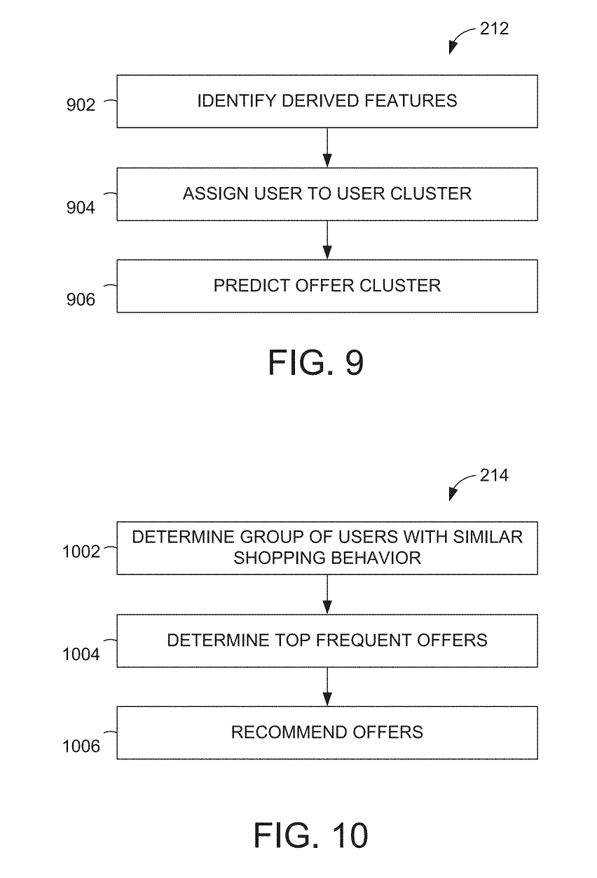

The prediction module 116 is configured to predict (e.g., select or assign) an offer cluster applicable for a new user. In particular, the new user is assigned to a user cluster and a corresponding offer cluster is selected. Operations of the user prediction module 116 are discussed in more detail in connection with FIG. 9.

The recommendation module 118 is configured to select a specific offer from the offer cluster predicted by the prediction module 116. Operations of the user prediction module 116 are discussed in more detail in connection with FIG. 10.

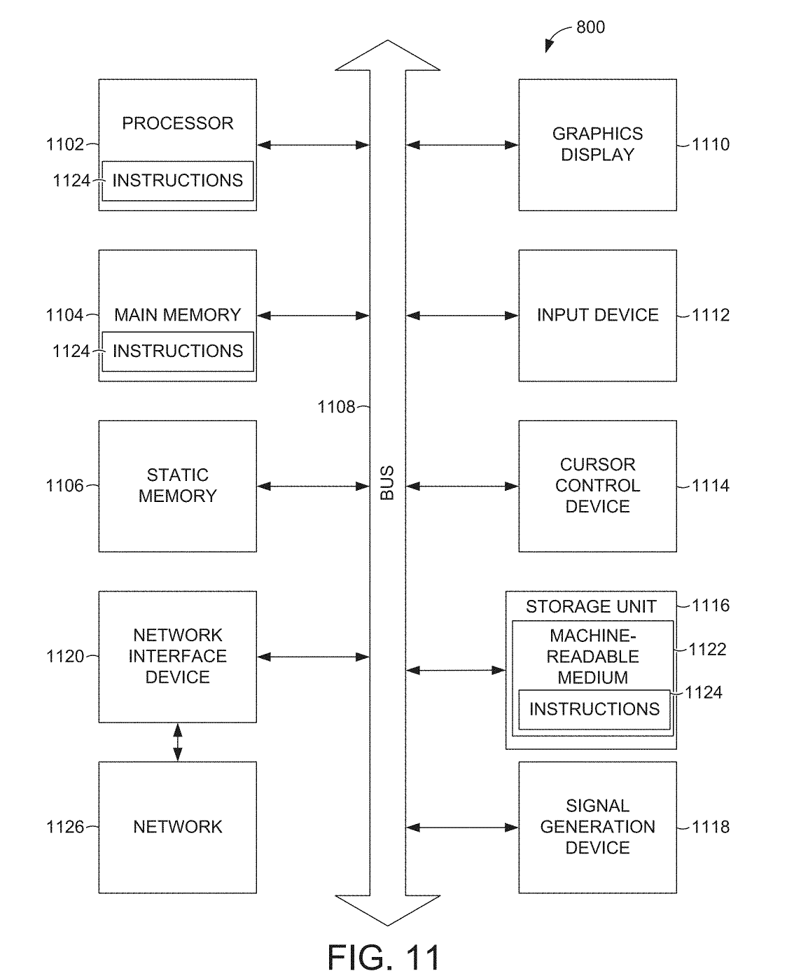

It is noted that offer management system 100 shown in FIG. 1 is merely an example. Any of the systems or components (e.g., datastores, modules, engines, servers) shown in FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 11, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Any one or more of the components (e.g., modules) described herein may be implemented using hardware alone (e.g., one or more processors of a machine) or a combination of hardware and software. For example, any component described herein may physically include an arrangement of one or more of the processors or configure a processor (e.g., among one or more processors of a machine) to perform the operations described herein for that module. Accordingly, different components described herein may include and configure different arrangements of the processors at different points in time or a single arrangement of the processors at different points in time. Each component (e.g., module) described herein is an example of a means for performing the operations described herein for that component. Moreover, any two or more of these components may be combined into a single component, and the functions described herein for a single component may be subdivided among multiple components. Furthermore, according to various example embodiments, components described herein as being implemented within a single machine, database, or device may be distributed across multiple machines, databases, or devices.

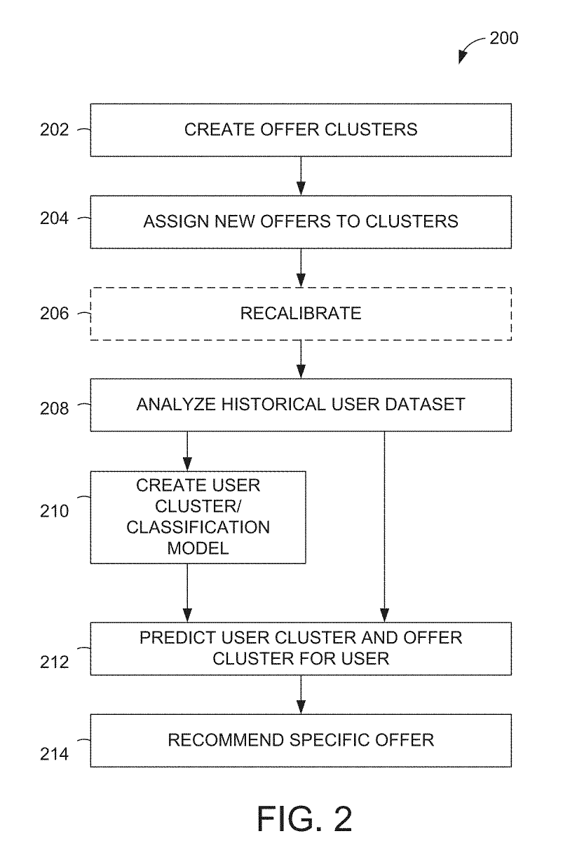

FIG. 2 is a flowchart illustrating operations of a method 200 for training a machine for adaptive offer targeting and recommending relevant offers to a user, according to some example embodiments. Operations in the method 200 may be performed by the offer management system 100, using modules described above with respect to FIG. 1. Accordingly, the method 200 is described by way of example with reference to the offer management system 100. However, it shall be appreciated that at least some of the operations of the method 200 may be deployed on various other hardware configurations or be performed by similar components residing elsewhere. Therefore, the method 200 is not intended to be limited to the offer management system 100.

In operation 202, offer clusters (and corresponding cluster index) are created. In example embodiments, the cluster generation module 106 applies clustering algorithms in order to group existing offers into a plurality of offer clusters where the offers in the same cluster share similar offer features. Operation 202 will be discussed in more detail in connection with FIG. 3 below. It is noted that operation 202 may only be performed periodically or only once (e.g., in view of operation 206).

In operation 204, a new offer is assigned to one of the offer clusters. In example embodiments, the cluster association module 108 assigns the new offer to the offer cluster based on a distance between the new offer and a centroid of the assigned offer cluster being a smallest distance. In example embodiments, the new offer can be added and recommended without retraining the model (e.g., without re-deriving the plurality of offer clusters). Operation 204 is discussed in more detail in connection with FIG. 5 below.

In operation 206, recalibration may occur. In example embodiments, the recalibration module 110 determines, after a change in a threshold number of offers (e.g., after 100 new offers are added to the system, after 100 offers have been removed from the system, after 200 offers have been added or removed from the system), whether one or more offer clusters need to be adjusted. Adjusting the offer clusters does not require a retraining of the entire system or model, just a change to the affected offer clusters. Operation 206 is discussed in more detail in connection with FIG. 6. It is noted that operation 206 is optional or only performed periodically.

In operation 208, historical user data is analyzed by the analysis module 112. In particular, the analysis module 112 manages mapping of each offer option (e.g., an offer that was selected by previous users) from the historical user data to an offer cluster (e.g., cluster index) created by the cluster engine 102 by analyzing a dataset of historical user data (e.g., historical offer accepting records) that represents user purchasing behavior. As a result, an accepted offer identifier of the offer option is replaced with a corresponding offer cluster index identifier. Operation 208 is discussed in more detail in connection with FIG. 7.

In operation 210, user clusters are extracted and an individual classification model is trained for each user cluster. In example embodiments, the behavior analysis module 114 trains/learns classification models for the user clusters. In particular, the behavior analysis module 114 applies clustering algorithms in order to group users into user clusters where the users in the same user cluster share similar attributes and/or interactions. A classification model is trained for each user cluster, which maps the user purchasing behavior to offer clusters. Operation 210 is discussed in more detail in connection with FIG. 8 below. It is noted that operations 208 and 210 may only be performed occasionally (e.g., when there is a change in the plurality of offer clusters).

In operation 212, a user cluster is predicted (e.g., selected or assigned to) for a new user by the prediction module 116. In example embodiments, the prediction module 116 uses the output of operations 208 and 210 in performing the prediction. Operation 212 is discussed in more detail in connection with FIG. 9 below.

In operation 214, the recommendation module 118 selects and recommends a specific offer (or offers) from the predicted offer cluster that is most relevant for the predicted user cluster in operation 212. Operation 214 is discussed in more detail in connection with FIG. 10 below. Operations 212 and 214 comprise a recommendation process performed for the new user that results in a determination of one or more relevant offers to be recommended to the new user.

FIG. 3 is a flowchart illustrating operations of a method (e.g., operation 202) for training the cluster engine 102, which includes creating offer clusters, according to some example embodiments. Operations in the method may be performed by the cluster engine 102, using one or more modules described above with respect to FIG. 1 (e.g., the cluster generation module 106). Accordingly, the method is described by way of example with reference to the cluster engine 102. However, it shall be appreciated that at least some of the operations of the method may be deployed on various other hardware configurations or be performed by similar components residing elsewhere in the offer management system 100. Therefore, the method is not intended to be limited to the cluster engine 102.

In operation 302, historical offer data is obtained (e.g., retrieved from the offer datastore 120) by the cluster generation module 106. The historical offer data includes both information about offers and items (e.g., products). As such the historical offer data may comprise, for example, normal price, sales unit, amount, scale price, duration, discount, reward type (e.g., cash, loyalty points, coupon), magnitude of discount/reward, target group of users, and regional validity.

In example, embodiments, the cluster generation module 106 analyzes the historical offer data and groups offers having similar offer data features together. In determining the offer clusters (e.g., also referred to as “clustering training process”), several considerations are taken into consideration by the cluster generation module 106. One consideration is that offers may have different structures. As a simplest example, one offer is defined as a discount of products, where users accept the offer when they buy the (discounted) products. In a more complicated example, an offer may involve multiple products for purchase, and the user chooses multiple products as a benefit of the offer. It is noted that the offer clustering process of FIG. 3 is designed to hide variations of offers from a recommendation process. As such, changes on offer features will not affect the recommendation process.

Depending on requirements, the cluster generation module 106 selects an appropriate clustering method for use. One clustering method is the K-means method. For a soft clustering process, the Fuzzy C Means may be used, where each point has a membership value associated with each offer cluster. Furthermore, it is possible to assume offer clusters can overlap where one data point belongs to multiple offer clusters.

In example embodiments, operation 304 comprises determining an optimal number of non-overlapping offer clusters and preserving a cluster centroid for each offer cluster. For clustering methods that require specifying the optimal number of offer clusters, validity index techniques (e.g., calculations) are used to evaluate clustering output. Two measurement criteria used to select an optimal clustering schema are cohesion and separation. Cohesion indicates closeness of data points in the same clusters and separation measures how two distinct clusters are separated.

Index calculations may be performed to measure cohesion or separation. One such index calculation used to measure cluster cohesion is with-cluster sum of square (SSE). The sum of squared within-cluster distance is calculated by

$$\text{?} {‖ \text{?} - {m}_{c} ‖}^{2} . \\ \text{?} \text{indicates text missing or illegible when filed}$$

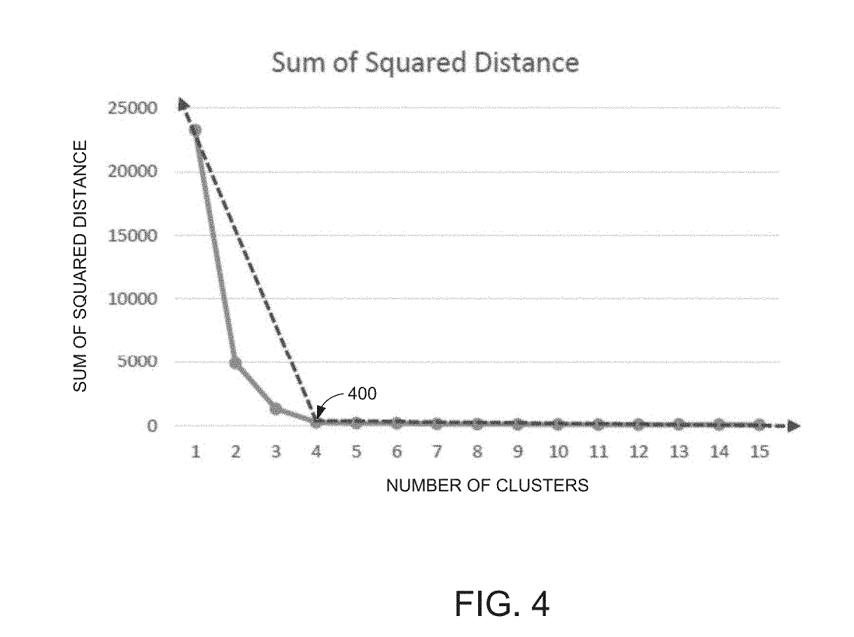

In particular, a range of numbers of clusters is pre-defined. Then the same clustering algorithm is performed based on the same dataset repeatedly with different number of clusters specified. Each clustering configuration is evaluated by calculating the within-cluster distance, where, as a result, a SSE curve is obtained as shown in FIG. 4. To determine the optimal number of offer clusters, a point 400 that acts as a knee along the curve, is identified and the corresponding number of clusters (e.g., four) is determined to be the optimal number.

Another index calculation that may be used by the offer training module 106 is Silhouette Index, which considers both cohesion and separation. Silhouette index is calculated by:

$$\frac{1}{NC} \text{?} \frac{1}{\text{?}} \text{?} \frac{b ( x ) - a ( x )}{max [ b ( x ) , a ( x ) ]} . \\ \text{?} \text{indicates text missing or illegible when filed}$$

where a(x) is an average distance of data point x and other points in the same cluster, which is calculated by:

$$a ( x ) = \frac{1}{\text{?}} \text{?} d ( x - \text{?} ) . \\ \text{?} \text{indicates text missing or illegible when filed}$$

b(x) is the average distance of point x and other clusters, which calculated a by:

$$b ( x ) = \text{?} \{ \frac{1}{\text{?}} \text{?} d ( x , y ) \} . \\ \text{?} \text{indicates text missing or illegible when filed}$$

In operation 306, each offer of the data set is associated with a particular offer cluster and an associated cluster identifier.

FIG. 5 is a flowchart illustrating operations of a method (e.g., operation 204) for assigning a new offer to one of the plurality of offer clusters generated in operation 202, according to some example embodiments. Operations in the method may be performed by the cluster engine 102, using one or more modules described above with respect to FIG. 1 (e.g., cluster association module 108). Accordingly, the method is described by way of example with reference to the cluster engine 102. However, it shall be appreciated that at least some of the operations of the method may be deployed on various other hardware configurations or be performed by similar components residing elsewhere in the offer management system 100. Therefore, the method is not intended to be limited to the cluster engine 102.

In operation 502, new offer data is received and analyzed by the cluster association module 108. The new offer may then be assigned to an optimal offer cluster (e.g., having a same data structure and similar features) based on the new offer data.

In operation 504, the cluster association module 108 computes a proximity (e.g., distance) to the centroid of each offer cluster. Specifically, offer attributes of the new offer are compared with the centroid of one offer cluster, where the Euclidean distance is calculated to indicate the similarity between the new offer and the cluster centroid.

In operation 506, the new offer is associated with an optimal offer cluster and its corresponding cluster identifier. In example embodiments, the optimal offer cluster is the offer cluster having the smallest distance (e.g., calculated in operation 504) to the centroid. As a result, the new offer is assigned to the optimal offer cluster with most similar features.

FIG. 6 is a flowchart illustrating operations of a method (e.g., operation 206) for dynamically recalibrating offer clusters, according to some example embodiments. Operations in the method may be performed by the cluster engine 102, using one or more modules described above with respect to FIG. 1 (e.g., the recalibration module 110). Accordingly, the method is described by way of example with reference to the cluster engine 102. However, it shall be appreciated that at least some of the operations of the method may be deployed on various other hardware configurations or be performed by similar components residing elsewhere in the offer management system 100. Therefore, the method is not intended to be limited to the cluster engine 102.

In example embodiments, the recalibration module 110 determines whether an adjustment should be made to one or more offer clusters. In example embodiments, the determination may be dynamically performed after a threshold number of new offers have been added to the offer management system 100. While example embodiments discuss the trigger for initiating the recalibration process as being a threshold number of new offers, alternative embodiments may trigger the recalibration process based on any change in threshold number of offers (e.g., a combination of adding new offers and removing expired offers) or removal of a threshold number of expired offers.

The recalibration module 110 performs the recalibration in order to optimize the offer clusters since, during one lifecycle of a clustering model, there may be a large number of new offers created (or changes in offers available). When these new offers are assigned to existing offer clusters (or changes in offers available affect the offer clusters), it is possible that two offer clusters that were originally separated become similar (or identical). These two offer clusters should then be merged into a single offer cluster. Alternatively, a single offer cluster should be split into smaller clusters when new offers are assigned to the offer cluster (or changes in offers available affect the offer cluster) and there are new smaller clusters appearing.

As shown in the method of FIG. 6, a cluster(s) splitting/merging algorithm is applied by the recalibration module 110. In operation 602, quality of the cluster are computed. In example embodiments, the validity index (as discussed above with respect to FIG. 3) is calculated to evaluate any change on the existing offer clusters (e.g., index calculations performed) to measure cohesion or separation). A determination is made in operation 604 as to whether each offer cluster is compact (e.g., the offers assigned to the same cluster are tightly united within a predetermined threshold). If the offer clusters are compact, then no recalibration (e.g., changes in offer clusters) is needed and the plurality of offer clusters continue to be used in the recommendation process (e.g., performed by the recommendation engine 104) in operation 606. However, if one or more clusters are not compact, then in operation 608, the recalibration module 110 either causes an offer cluster to split or causes two or more offer clusters to be merged into a single offer cluster. In some embodiments, when there is an improvement made on the existing offer clusters, the offer recommendation portion may be retrained.

FIG. 7 is a flowchart illustrating operations of a method (e.g., operation 208) for processing historical user data, according to some example embodiments. Operations in the method may be performed by the recommendation engine 104, using one or more modules described above with respect to FIG. 1 (e.g., the analysis module 112). Accordingly, the method is described by way of example with reference to recommendation engine 104. However, it shall be appreciated that at least some of the operations of the method may be deployed on various other hardware configurations or be performed by similar components residing elsewhere in the offer management system 100. Therefore, the method is not intended to be limited to recommendation engine 104.

In operation 702, the analysis module 112 obtains and analyze analytical data (e.g., the historical user data from the user datastore 122). In example embodiments, the analytics data comprises a training dataset including user data (e.g., demographics such as age and gender), product data (e.g. information of product being viewed or ordered by the user), location data, transaction data (e.g. observed user behavior before accepting one offer, for instance, number of times viewing products/offer items, basket items added by the user), and accepted offer option from past transactions or orders. The analysis module 112 observes user interests on offers by analyzing historical acceptance of offers by users in their past orders. Interest may also include interactions such as viewing offers or liking offers. As such, to observe user interest on offers, historical user data (also referred to as “historical offer accepting data”) is used as the training dataset. Specifically, the customer data, the product data, the location data, and the transaction data are used to represent user purchase behavior. Each purchase transaction record is associated with one offer option that is accepted in that transaction. The training dataset indicates, with a particular user purchase behavior, an offer option that tends to be accepted.

In operation 704, the analysis module 112 maps the offer option to a cluster index (e.g., to an offer cluster). In order to map user purchase behaviors to the corresponding offer cluster, a classification algorithm is performed by the recommendation training module 112, where user information, interactions, and ordering are used as input of a classification model. Instead of considering individual offers as a target, the accepted offer (e.g., the offer option) is replaced by its corresponding offer cluster (e.g., the offer cluster index), which is used as the target of classification. Since the number of offer clusters is usually defined to be greater than two, multi-class classification is considered. Example classification algorithms that natively support multi-class classification and can be used by the recommendation training module 112 include Decision Tree and Random Forest.

FIG. 8 is a flowchart illustrating operations of a method (e.g., operation 210) for creating user clusters, according to some example embodiments. Operations in the method may be performed by the recommendation engine 104, using modules described above with respect to FIG. 1 (e.g., the behavior analysis module 114). Accordingly, the method is described by way of example with reference to recommendation engine 104. However, it shall be appreciated that at least some of the operations of the method may be deployed on various other hardware configurations or be performed by similar components residing elsewhere in the offer management system 100. Therefore, the method is not intended to be limited to recommendation engine 104.

The method groups users into user clusters based on historical purchasing behaviors. In operation 802, the behavior analysis module 114 derives (e.g., identifies) features from the historical user data. Thus, user historical user data is used as input by behavior analysis module 114, and patterns with similar purchasing behavior (e.g., the derived features) are extracted by the behavior analysis module 114.

In operation 804, the behavior analysis module 114 clusters users into N number of user clusters, each user cluster having a cluster centroid. The optimal number of user clusters can be identified by following the same method as with the optimal number of offer clusters. Accordingly, the behavior analysis module 114 groups users based on the similar purchasing behavior. The users are grouped without taking offers into consideration.

In operation 806, the behavior analysis module 114 creates a classification model for each user cluster. It is presumed that users with similar purchasing behaviors have similar interest in offers. Thus for each user cluster, an individual multi-class classification model is built to predict a most likely accepted offer cluster (or offer cluster index). Specifically, the historical offer accepting data in the analysis module 112 is used as training data. For each transaction record, the customer information, the product information, the location information, and the transaction information are used as input of the classification model and the accepted offer cluster index is used as the target for training. Therefore, when the classification model is built based on a user cluster, the offer clusters are narrowed down to a user cluster where those offer clusters that are particularly interesting to the user cluster become much more obvious.

FIG. 9 is a flowchart illustrating operations of a method (e.g., operation 212) for predicting an offer cluster for a new user, according to some example embodiments. Operations in the method may be performed by the recommendation engine 104, using one or more modules described above with respect to FIG. 1 (e.g., the prediction module 116). Accordingly, the method is described by way of example with reference to recommendation engine 104. However, it shall be appreciated that at least some of the operations of the method may be deployed on various other hardware configurations or be performed by similar components residing elsewhere in the offer management system 100. Therefore, the method is not intended to be limited to recommendation engine 104.

In operation 902, the prediction module 116 derives (e.g., identifies) features for the new user that is performing a purchase transaction. Operation 902 is similar to operation 802, in that same attributes or features used in the training stage (operation 802) are identified, however purchase data from the purchase transaction is used as input by the prediction module 116. The features may comprise, for example, product type, user data (e.g., demographics), and transaction data.

In operation 904, the prediction module 116 assigns the new user to one of the user clusters. The assigned user cluster is chosen based on the user cluster being most similar based on the derived features (e.g., a smallest distance to a user cluster centroid of the assigned user cluster). Operation 904 is similar in nature to operation 504 and 506 whereby a new offer is assigned an offer cluster based on proximity (e.g., smallest distance) to a centroid of the offer cluster.

In operation 906, the prediction module 116 predicts (e.g., identifies, selects) the offer cluster for the new user based on the assigned user cluster. In particular, the prediction module 116 identifies a most relevant offer cluster for the assigned user based on the offer classification model (discussed in operation 806 of FIG. 8). Specifically, the classification model that is associated with the selected user cluster is used to predict the offer cluster that the new user is most likely to opt for.

FIG. 10 is a flowchart illustrating operations of a method (e.g., operation 214) for selecting a specific offer for the new user from the predicted or selected offer cluster, according to some example embodiments. Operations in the method may be performed by the recommendation engine 104, using one or more modules described above with respect to FIG. 1 (e.g., the recommendation module 118). Accordingly, the method is described by way of example with reference to recommendation engine 104. However, it shall be appreciated that at least some of the operations of the method may be deployed on various other hardware configurations or be performed by similar components residing elsewhere in the offer management system 100. Therefore, the method is not intended to be limited to recommendation engine 104.

Based on the prediction from the offer classification model (e.g., operation 906 of FIG. 6), the method of FIG. 10 provides a mechanism to select and recommend optimal relevant offers from the selected offer cluster based on the specific user purchase transaction. In operation 1002, the recommendation module 118 determines a group (e.g., subset) of users from the user cluster with similar shopping behavior. For example, the group may have bought similar product offerings in the past to the one currently being purchased by the new user and have selected offers from the offer cluster that is predicted for the new user (e.g., operation 906 of FIG. 9). As such, the recommendation module 118 selects offers by investigating accepted offers by other users who have similar offer interests and similar purchase/shopping history or behavior. Specifically, when the new user makes an order and an offer cluster is predicted by the classification model, users from the user cluster are filtered to derive the group of users who have similar purchase transactions and accepted an offer from the predicted offer cluster. Since groups of users are limited to be in the same predicted user cluster and have similar ordering history, the group of users are supposed to have similar interest in offers from the predicted offer cluster.

In operation 1004, the recommendation module 118 determines top frequent offers for the new user based on offers (from the predicted offer cluster) selected by the group of users. In particular, offers from the selected offer cluster are ranked by looking at users from the assigned user cluster (e.g., what these users bought and offers they accepted). The highest ranked offers (e.g., most frequently accepted) are likely the optimal relevant offers to be recommended to the new user. Additionally or alternatively, the top frequent offers may be determined based on rules. For example, the recommendation module 118 may recommend an offer with the highest margin for a retailer.

In operation 1006, one or more of the top frequent offers are recommended for the new user. That is, the recommendation module 118 may return, to the new user, the top frequent offers in an offer recommendation.

According to various example embodiments, one or more of the methodologies described herein may facilitate training a machine for adaptive offer targeting and recommending relevant offers. In particular, one or more of the methodologies described herein may constitute all or part of a method (e.g., a method implemented using a machine) that dynamically processes offers in an offer clustering component separate from a recommendation component, which leads to a flexible way to handle offers with different structures and life cycles easily. Offers can be included or excluded without affecting the recommendation component. Additionally, recommendation models do not need to be frequently retrained even if offers have very short life cycles. This results in reduced model management and processing. When these effects are considered in aggregate, one or more of the methodologies described herein may obviate a need for certain efforts or resources that otherwise would be involved in constantly retraining recommendation models. Computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 11 illustrates components of a machine 1100, according to some example embodiments, that is able to read instructions from a machine-readable medium (e.g., a machine-readable storage device, a non-transitory machine-readable storage medium, a computer-readable storage medium, or any suitable combination thereof) and perform any one or more of the methodologies discussed herein. Specifically, FIG. 11 shows a diagrammatic representation of the machine 1100 in the example form of a computer device (e.g., a computer) and within which instructions 1124 (e.g., software, a program, an application, an applet, an app, or other executable code) for causing the machine 1100 to perform any one or more of the methodologies discussed herein may be executed, in whole or in part.

For example, the instructions 1124 may cause the machine 1100 to execute the flow diagrams of FIGS. 2, 3, and 5-10. In one embodiment, the instructions 1124 can transform the general, non-programmed machine 1100 into a particular machine (e.g., specially configured machine) programmed to carry out the described and illustrated functions in the manner described.

In alternative embodiments, the machine 1100 operates as a standalone device or may be connected (e.g., networked) to other machines. In a networked deployment, the machine 1100 may operate in the capacity of a server machine or a client machine in a server-client network environment, or as a peer machine in a peer-to-peer (or distributed) network environment. The machine 1100 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1124 (sequentially or otherwise) that specify actions to be taken by that machine. Further, while only a single machine is illustrated, the term “machine” shall also be taken to include a collection of machines that individually or jointly execute the instructions 1124 to perform any one or more of the methodologies discussed herein.

The machine 1100 includes a processor 1102 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1104, and a static memory 1106, which are configured to communicate with each other via a bus 1108. The processor 1102 may contain microcircuits that are configurable, temporarily or permanently, by some or all of the instructions 1124 such that the processor 1102 is configurable to perform any one or more of the methodologies described herein, in whole or in part. For example, a set of one or more microcircuits of the processor 1102 may be configurable to execute one or more modules (e.g., software modules) described herein.

The machine 1100 may further include a graphics display 1110 (e.g., a plasma display panel (PDP), a light emitting diode (LED) display, a liquid crystal display (LCD), a projector, or a cathode ray tube (CRT), or any other display capable of displaying graphics or video). The machine 1100 may also include an alphanumeric input device 1112 (e.g., a keyboard), a cursor control device 1114 (e.g., a mouse, a touchpad, a trackball, a joystick, a motion sensor, or other pointing instrument), a storage unit 1116, a signal generation device 1118 (e.g., a sound card, an amplifier, a speaker, a headphone jack, or any suitable combination thereof), and a network interface device 1120.

The storage unit 1116 includes a machine-readable medium 1122 (e.g., a tangible machine-readable storage medium) on which is stored the instructions 1124 (e.g., software) embodying any one or more of the methodologies or functions described herein. The instructions 1124 may also reside, completely or at least partially, within the main memory 1104, within the processor 1102 (e.g., within the processor's cache memory), or both, before or during execution thereof by the machine 1100. Accordingly, the main memory 1104 and the processor 1102 may be considered as machine-readable media (e.g., tangible and non-transitory machine-readable media). The instructions 1124 may be transmitted or received over a network 1126 via the network interface device 1120.

In some example embodiments, the machine 1100 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 1122 able to store data temporarily or permanently and may be taken to include, but not be limited to, random-access memory (RAM), read-only memory (ROM), buffer memory, flash memory, and cache memory. While the machine-readable medium 1122 is shown in an example embodiment to be a single medium, the term “machine-readable medium” should be taken to include a single medium or multiple media (e.g., a centralized or distributed database, or associated caches and servers) able to store instructions (e.g., instructions 1124). The term “machine-readable medium” shall also be taken to include any medium, or combination of multiple media, that is capable of storing instructions (e.g., software) for execution by the machine (e.g., machine 1100), such that the instructions, when executed by one or more processors of the machine (e.g., processor 1102), cause the machine to perform any one or more of the methodologies described herein. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof. In some embodiments, a “machine-readable medium” may also be referred to as a “machine-readable storage device” or a “hardware storage device.”

Furthermore, the machine-readable medium 1122 is non-transitory in that it does not embody a propagating or transitory signal. However, labeling the machine-readable medium 1122 as “non-transitory” should not be construed to mean that the medium is incapable of movement—the medium should be considered as being transportable from one physical location to another. Additionally, since the machine-readable medium 1122 is tangible, the medium may be considered to be a tangible machine-readable storage device.

In some example embodiments, the instructions 1124 for execution by the machine 1100 may be communicated by a carrier medium. Examples of such a carrier medium include a storage medium (e.g., a non-transitory machine-readable storage medium, such as a solid-state memory, being physically moved from one place to another place) and a transient medium (e.g., a propagating signal that communicates the instructions 1124)

The instructions 1124 may further be transmitted or received over a communications network 1126 using a transmission medium via the network interface device 1120 and utilizing any one of a number of well-known transfer protocols (e.g., HTTP). Examples of communication networks 1126 include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions 1124 for execution by the machine 1100, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

### Examples

Example 1 is a method for training a machine to perform adaptive content targeting. The method comprises generating, by a cluster engine, a recommendation model, the generating of the recommendation model comprising creating a plurality of offer clusters, each offer cluster comprising offers having similar features; assigning, by the cluster engine, a new offer to one of the plurality of offer clusters, the assigning of the new offer occurring without having to retrain the recommendation model; generating, by a recommendation engine, a plurality of user clusters, users within each of the plurality of user clusters sharing similar behavior; creating, by a hardware processor of the recommendation engine, a classification model for predicting an offer cluster from the plurality of offer clusters for each of the plurality of user clusters; and performing, by the recommendation engine, a recommendation process for a new user, the performing the recommendation process comprising selecting one or more relevant offers from a predicted offer cluster based on the classification model.

In example 2, the subject matter of example 1 can optionally include performing a determination as to whether recalibration of the recommendation model is required, the recalibration causing an adjustment to an affected offer cluster of the plurality of offer clusters.

In example 3, the subject matter of examples 1-2 can optionally include wherein the adjustment comprises a split of the affected offer cluster or a merge of the affected offer cluster with a second affected offer cluster.

In example 4, the subject matter of examples 1-3 can optionally include wherein the performing the determination as to whether recalibration of the recommendation model is required comprises performing index calculations to measure cohesion or separation.

In example 5, the subject matter of examples 1-4 can optionally include wherein the performing the determination is triggered based on a threshold number of changes in offers occurring.

In example 6, the subject matter of examples 1-5 can optionally include wherein the performing the recommendation process comprises predicting a user cluster of the plurality of user clusters assigned to the new user; and identifying the predicted offer cluster that corresponds to the predicted user cluster based on the classification model.

In example 7, the subject matter of examples 1-6 can optionally include wherein the selecting one or more relevant offers comprises determining a group of users within the predicted user cluster with similar behavior as the new user; and ranking offers within the predicted offer cluster based on acceptance of the offers by the group of users.

In example 8, the subject matter of examples 1-7 can optionally include wherein the creating the plurality of offer clusters comprises determining an optimal number of non-overlapping offer clusters, the determining the optimal number being based on index calculations.

In example 9, the subject matter of examples 1-8 can optionally include wherein the assigning the new offer to one of the plurality of offer clusters comprises computing a distance to a centroid of each of the plurality of offer clusters, and associating the new offer with an offer cluster with a shortest distance to the centroid.

In example 10, the subject matter of examples 1-9 can optionally include analyzing historical offer accepting data, the historical offer accepting data including an offer option accepted by a particular user for each transaction; and mapping the offer option to one of the plurality of offer clusters.

Example 11 is a hardware storage device for training a machine to perform adaptive content targeting. The hardware storage device configures one or more processors to perform operations comprising generating a recommendation model, the generating of the recommendation model comprising creating a plurality of offer clusters, each offer cluster comprising offers having similar features; assigning a new offer to one of the plurality of offer clusters, the assigning of the new offer occurring without having to retrain the recommendation model; generating a plurality of user clusters, users within each of the plurality of user clusters sharing similar behavior; creating a classification model for predicting an offer cluster from the plurality of offer clusters for each of the plurality of user clusters; and performing a recommendation process for a new user, the performing the recommendation process comprising selecting one or more relevant offers from a predicted offer cluster based on the classification model.

In example 12, the subject matter of example 11 can optionally include wherein the operations further comprise performing a determination as to whether recalibration of the recommendation model is required, the recalibration causing an adjustment to an affected offer cluster of the plurality of offer clusters.

In example 13, the subject matter of examples 11-12 can optionally include wherein the performing the recommendation process comprises: predicting a user cluster of the plurality of user clusters assigned to the new user; and identifying the predicted offer cluster that corresponds to the predicted user cluster based on the classification model.

In example 14, the subject matter of examples 11-13 can optionally include wherein the selecting one or more relevant offers comprises: determining a group of users within the predicted user cluster with similar behavior as the new user; and ranking offers within the predicted offer cluster based on acceptance of the offers by the group of users.

In example 15, the subject matter of examples 11-14 can optionally include wherein the creating the plurality of offer clusters comprises determining an optimal number of non-overlapping offer clusters, the determining the optimal number being based on index calculations.

Example 16 is a system for training a machine to perform adaptive content targeting. The system comprises one or more hardware processors; and a storage device storing instructions that, when executed by the one or more hardware processors, causes the one or more hardware processors to perform operations. The operations comprise generating a recommendation model, the generating of the recommendation model comprising creating a plurality of offer clusters, each offer cluster comprising offers having similar features; assigning a new offer to one of the plurality of offer clusters, the assigning of the new offer occurring without having to retrain the recommendation model; generating a plurality of user clusters, users within each of the plurality of user clusters sharing similar behavior; creating a classification model for predicting an offer cluster from the plurality of offer clusters for each of the plurality of user clusters; and performing a recommendation process for a new user, the performing the recommendation process comprising selecting one or more relevant offers from a predicted offer cluster based on the classification model

In example 17, the subject matter of example 16 can optionally include performing a determination as to whether recalibration of the recommendation model is required, the recalibration causing an adjustment to an affected offer cluster of the plurality of offer clusters.

In example 18, the subject matter of examples 16-17 can optionally include wherein the performing the recommendation process comprises: predicting a user cluster of the plurality of user clusters assigned to the new user; and identifying the predicted offer cluster that corresponds to the predicted user cluster based on the classification model.

In example 19, the subject matter of examples 16-18 can optionally include wherein the selecting one or more relevant offers comprises: determining a group of users within the predicted user cluster with similar behavior as the new user; and ranking offers within the predicted offer cluster based on acceptance of the offers by the group of users.

In example 20, the subject matter of examples 16-19 can optionally include wherein the creating the plurality of offer clusters comprises determining an optimal number of non-overlapping offer clusters, the determining the optimal number being based on index calculations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
generating, by a cluster engine, a recommendation model, the generating of the recommendation model comprising creating a plurality of offer clusters, each offer cluster comprising offers having similar features;
assigning, by the cluster engine, a new offer to one of the plurality of offer clusters, the assigning of the new offer occurring without having to retrain the recommendation model;
generating, by a recommendation engine, a plurality of user clusters, users within each of the plurality of user clusters sharing similar behavior;
creating, by a hardware processor of the recommendation engine, a classification model for predicting an offer cluster from the plurality of offer clusters for each of the plurality of user clusters; and
performing, by the recommendation engine, a recommendation process for a new user, the performing the recommendation process comprising selecting one or more relevant offers from a predicted offer cluster based on the classification model.

2. The method of claim 1, further comprising performing a determination as to whether recalibration of the recommendation model is required, recalibration causing an adjustment to an affected offer cluster of the plurality of offer clusters.

3. The method of claim 2, wherein the adjustment comprises a split of the affected offer cluster or a merge of the affected offer cluster with a second affected offer cluster.

4. The method of claim 2, wherein the performing the determination as to whether recalibration of the recommendation model is required comprises performing index calculations to measure cohesion or separation.

5. The method of claim 2, wherein the performing the determination is triggered based on a threshold number of changes in offers occurring.

6. The method of claim 1, wherein the performing the recommendation process comprises:
predicting a user cluster of the plurality of user clusters assigned to the new user; and
identifying the predicted offer cluster that corresponds to the predicted user cluster based on the classification model.

7. The method of claim 6, wherein the selecting one or more relevant offers comprises:
determining a group of users within the predicted user cluster with similar behavior as the new user; and
ranking offers within the predicted offer cluster based on acceptance of the offers by the group of users.

8. The method of claim 1, wherein the creating the plurality of offer clusters comprises determining an optimal number of non-overlapping offer clusters, the determining the optimal number being based on index calculations.

9. The method of claim 1, wherein the assigning the new offer to one of the plurality of offer clusters comprises:
computing a distance to a centroid of each of the plurality of offer clusters; and
associating the new offer with an offer cluster with a shortest distance to the centroid.

10. The method of claim 1, further comprising:
analyzing historical offer accepting data, the historical offer accepting data including an offer option accepted by a particular user for each transaction; and
mapping the offer option to one of the plurality of offer clusters.

11. A hardware storage device storing instructions that, when executed by one or more processors of a machine, cause the machine to perform operations comprising:
generating a recommendation model, the generating of the recommendation model comprising creating a plurality of offer clusters, each offer cluster comprising offers having similar features;
assigning a new offer to one of the plurality of offer clusters, the assigning of the new offer occurring without having to retrain the recommendation model;
generating a plurality of user clusters, users within each of the plurality of user clusters sharing similar behavior;
creating a classification model for predicting an offer cluster from the plurality of offer clusters for each of the plurality of user clusters; and
performing a recommendation process for a new user, the performing the recommendation process comprising selecting one or more relevant offers from a predicted offer cluster based on the classification model.

12. The hardware storage device of claim 11, wherein the operations further comprise performing a determination as to whether recalibration of the recommendation model is required, recalibration causing an adjustment to an affected offer cluster of the plurality of offer clusters.

13. The hardware storage device of claim 11, wherein the performing the recommendation process comprises:
predicting a user cluster of the plurality of user clusters assigned to the new user; and
identifying the predicted offer cluster that corresponds to the predicted user cluster based on the classification model.

14. The hardware storage device of claim 13, wherein the selecting one or more relevant offers comprises:
determining a group of users within the predicted user cluster with similar behavior as the new user; and
ranking offers within the predicted offer cluster based on acceptance of the offers by the group of users.

15. The hardware storage device of claim 11, wherein the creating the plurality of offer clusters comprises determining an optimal number of non-overlapping offer clusters, the determining the optimal number being based on index calculations.

16. A system comprising:
one or more hardware processors; and
a storage device storing instructions that, when executed by the one or more hardware processors, causes the one or more hardware processors to perform operations comprising:
generating a recommendation model, the generating of the recommendation model comprising creating a plurality of offer clusters, each offer cluster comprising offers having similar features;
assigning a new offer to one of the plurality of offer clusters, the assigning of the new offer occurring without having to retrain the recommendation model;
generating a plurality of user clusters, users within each of the plurality of user clusters sharing similar behavior;
creating a classification model for predicting an offer cluster from the plurality of offer clusters for each of the plurality of user clusters; and
performing a recommendation process for a new user, the performing the recommendation process comprising selecting one or more relevant offers from a predicted offer cluster based on the classification model.

17. The system of claim 16, further comprising performing a determination as to whether recalibration of the recommendation model is required, recalibration causing an adjustment to an affected offer cluster of the plurality of offer clusters.

18. The system of claim 16, wherein the performing the recommendation process comprises:
predicting a user cluster of the plurality of user clusters assigned to the new user; and
identifying the predicted offer cluster that corresponds to the predicted user cluster based on the classification model.

19. The system of claim 18, wherein the selecting one or more relevant offers comprises:
determining a group of users within the predicted user cluster with similar behavior as the new user; and
ranking offers within the predicted offer cluster based on acceptance of the offers by the group of users.

20. The system of claim 16, wherein the creating the plurality of offer clusters comprises determining an optimal number of non-overlapping offer clusters, the determining the optimal number being based on index calculations.
